(19) United States
(12) Patent Application Publication
(10) Pub. No.: US 2007/0269288 A1
(43) Pub. Date: Nov. 22, 2007

(54) Screw

(75) Inventor: Erich Palm, Au (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: SFS INTEC HOLDING AG, Heerbrugg, CH (CH)

(21) Appl. No.: 11/568,522

(22) PCT Filed: Jul. 9, 2005
(86) PCT No.: PCT/EP05/07443

§ 371 Date: Oct. 31, 2006

(30) Foreign Application Priority Data
Jul. 15, 2004 (DE) 10 2004 034 246.6

(51) Int. Cl. F16B 35/04

(52) U.S. Cl. 411/386

(57) ABSTRACT

A screw is provided having an at least partially threaded (4) shank (7) and a screw head (3). An unthreaded section (2) is provided between the screw head (3) and the thread (4). The thread (4), at least in the distal area of the shank (7) facing the screw head (3) is provided with a groove (5), notch, slot, or the like crossing the thread (4).

### BACKGROUND

The invention relates to a screw with an at least partially threaded shank as well as a screw head.

Screws of the type mentioned at the outset are known in the most different embodiments for various special applications.

### SUMMARY

The object of the invention is to provide a screw such that in particular thinner metal sheets can be connected to one another laterally with as high a degree of protection as possible from becoming loosened.

This is achieved according to the invention such that a section free from threads is provided between the screw head and the thread and that the thread is provided with at least one groove, notch, slot, or the like crossing the thread at the end region of the shank facing the screw head.

Through providing a thread-free section below the head, the screw is screwed into the sheet metal until it contacts below the head, with the bottom of the head acting as a stop. The second metal sheet is further screwed in. This ensures that the two metal sheets are pulled against one another. This achieves a higher degree of pre-tension of the screw. A reduction of this pre-tension is prevented by a groove being provided crossing the thread. Here, the groove in the thread creates a connection that is protected from being loosened. The edges of the groove act as engaging elements and thus contribute to an anchoring of the thread engaging at least the second metal sheet.

In one embodiment of the screw, the thread-free section has a smaller diameter than the root diameter of the threaded shank. This ensures that the sheet metal at the screw head does not cause resistance and thus the bottom of the head is used as much as possible as a stop during screwing down. If intentionally a form-fitting connection or one free from play is to be achieved below the head the diameter of the thread-free section may be equivalent to the diameter of the root diameter of the threaded shank or perhaps selected even slightly larger without creating any negative influence on the safety from being screwed loose.

In another embodiment of the screw, the width of the thread-free section is equivalent to a thickness of the metal sheet positioned next to the bottom of the head. This embodiment achieves an optimal condition with regard to the entire connection, because while the screw in the metal sheet next to the screw head can be freely rotated the second metal sheet is pulled against the first metal sheet with maximum force during the further screwing down of the screw.

In another embodiment of the screw, the width of the thread-free section is approximately equivalent to the thickness of all metal sheets to be connected to one another. This is a useful, simple way to prevent the reverse rotation of the screw in metal sheets which have entered the thread-free section in their entirety. In this case it is prevented that one of the two metal sheets can reengage the thread during the reverse rotation and loosening, respectively. Thus, no torque can be transferred between the metal sheets and the screw. A secure tightening without any torque-wrench is therefore easily possible in this embodiment. Security from loosening is also ensured in this case. This is also supported by the groove(s) crossing the thread.

In another embodiment of the screw, the groove tapers off in the thread-free section. This results in that a maximum effect of the groove being achieved, because particularly in thin metal sheets it is possible for the connection between the thread and the metal sheet to be created by less than one thread rotation. Only a groove tapering off in the thread-free section can ensure that the groove is engaging, if possible by the geometric conditions.

In another embodiment of the screw, the grooves, notches, slots, or the like are embodied U-shaped, V-shaped, or trapezoidally, or in any other shape forming a hollow space and form recesses in the teeth of the threads. The shape is selected such that it supports the forming of the thread and that the reverse rotation of the screw is possible only with very high reverse torque.

In another embodiment of the screw, two or more grooves are provided. This enhances the effect of the groove with regard to the reverse torque and the position. An enhancement can be achieved with each additional groove at the circumference of the thread. However, it must be taken into account that the function of the thread per se shall not be compromised by the implementation of an excessive number of grooves. In practical use, two to five grooves have proven useful, in particular.

In another embodiment of the screw, the groove extends parallel to an axis of the shank. This is technically easy to produce and fulfills the above-mentioned requirements.

In another embodiment of the screw, the groove, notch, slot, or the like extends clockwise and/or counter-clockwise in reference to the shank. In this manner, the effect can be adjusted more precisely to the application and thus the above-described requirements can be fulfilled even better. Particularly advantageous is a clockwise rotating groove, notch, slot, or the like with a low incline. In this embodiment the groove, notch, slot, or the like crossing the thread is created in the thread with an acute or obtuse angle. The acute angle leads to a higher reverse rotational torque of the screw and the acute angle reduces the milling of the sheet metal and thus increases the pulling torque of the screw.

Further, it is suggested that the groove, notch, slot, or the like are preferably provided to the depth of the root diameter of the thread. This way the limiting edge at the transfer between the teeth sides of the thread and the groove are provided in a length at which a maximum security from reverse torque is achieved by the length of the limiting edge.

In another embodiment of the screw, the groove, notch, slot, or the like is deeper than the core diameter of the thread. This ensures a very good shape of the sheet metal during the engagement.

In another embodiment of the screw, a binding and/or adhesive coating is applied at least on the part of the tread adjacent to the thread-free section. Through this coating, the binding effect, which is also determined by the geometric shape, is influenced in an extremely positive manner. A reverse rotation is hardly possible after a short period of time. Therefore, this can be called an optimum fastening.

It is known from professional literature that screwed connections can loosen, for example by interaction between tensions and compressions, heat-related expansion, shock and vibration related stress, wind vibrations, shaking, dynamic stress (swelling or alternating), reduced self resistance in multiple threads or by the application of circular springs. In the present invention an optimal, additional protection from the connection loosening can be yielded particularly by implementing grooves or by filling the hollow spaces with a binding and/or adhesive coating.

In addition to this short-term effect during the fastening process, the filling of the grooves, notches, slots, or the like with a coating is also used to constantly apply a coating to the thread during the screwing down process. This process already increases the reverse torque after a short period of time. In this way, a connection protected from reverse rotation is achieved already in metal sheets having a thickness of less than 0.5 mm.

In an additional embodiment of the screw, a clamping and/or adhesive coat is applied to the thread-free section and/or below the head. In thin metal sheets the coat acts in the tightened condition only in a very small area of the thread. By applying the coat to the thread-free section, prevention of the screw being moved by a low torque can be achieved. Even if the screwed connection cannot be loosened, the advantage of this embodiment comprises that the additional fixation of the screw prevents any unnecessary movement. This also prevents any potential jingling and/or vibration like the ones caused by wind impinging a façade.

In another embodiment of the invention, it is provided for the coat to be applied in form of a two-component adhesive of the like. Here, any known or newly developed adhesives can be applied which support the desired effects.

In another embodiment of the screw, plastic or the like is applied as a coat. Plastics can also be adjusted to the requirements of the screw connection and thus offer an ideal alternative to other coatings, e.g., in a liquid form.

In another embodiment of the screw wax, polytetrafluoroethylene (PTFE), plastics, or the like are applied as a lubricating coat at the end section of the shank facing away from the screw head. In order to reduce the thread-forming moment, a lubricating or gliding layer can be applied during the screwing down process at those points of the thread no longer in direct contact with one of the metal sheets after the connection has been tightened. This way the forming torque can be reduced. A screw connection is therefore enabled with a lower strength means, such as machine drills, among others. It provides a manual screwing down processes that allows less force to be applied while the screw can be screwed in faster.

In another embodiment of the screw, a coat is applied partially or covering the entire circumference. Even a partial coating acts to prevent a reverse torque. However, even partially applied lubricants are possible. Also, any combinations might be useful. They can be adjusted in any fashion to the requirements of the screw connection.

In another embodiment of the screw, the thread is arranged in an out of true manner at the end section of the shank facing away from the screw head. In addition to the non-cutting production of the female thread, this is also cold-hardened. A low screwing in moment results by a low material displacement.

In another embodiment of the screw the thread is embodied trilobularly. A form-fitting connection of the screw and the sheet metal is achieved by the high level of overlapping with teeth sides of the threads. This is a particularly important condition in thin metal sheets in order to accept high axial tensile forces.

In another embodiment of the screw, the shank is provided with a conical thread section at the end region of the shank facing away from the screw head. If pre-punched fastening holes are provided, an additional centering of the holes can be achieved thereby.

In another embodiment of the screw, the thread tapers off at the end facing away from the screw head. This way during the assembly process, pre-punched thin metal sheets up to almost the size of the diameter of the hole can be centered by the tip of the screw and thus forced into the correct position. This function is ensured even if the thread is not tapering off entirely at the tip. Even a cone-shaped tip can perform this function.

In another embodiment of the screw, a self-drilling or self-inserting tip is mounted at the side facing away from the drive connection, by which the hole is simultaneously created during the assembly process in already aligned metal sheets. This not only enhances the efficiency but also ensures that the diameter of the bore is ideally adjusted to the subsequent threading and tightening of the connection.

### BRIEF DESCRIPTION OF THE DRAWINGS

In the following, exemplary embodiments of the invention are explained in greater detail with reference being made to the drawings. They show:

FIG. 1 a first exemplary embodiment of a screw;

FIG. 2 an embodiment with grooves crossing the thread counter-clockwise;

FIG. 3 an embodiment with grooves crossing the thread clockwise;

FIG. 4 a cross-section along a line IV-IV in FIG. 2 with V-shaped grooves;

FIG. 5 a cross-section along a line IV-IV in FIG. 2 with trapezoidal grooves;

FIG. 6 a partial cross-section through an exemplary embodiment with two metal sheets, with a thread engagement being provided in the exterior metal sheets;

FIG. 7 a partial cross-section through an exemplary embodiment having two metal sheets, which engage at a thread-free section of the screw, with the thread no longer being inside the metal sheet;

FIG. 8 a partial cross-section through an exemplary embodiment having two metal sheets, with a screw being inserted having a partially coated thread;

FIG. 9 a partial cross-section through an exemplary embodiment having two metal sheets, with a screw being inserted having a partially coated groove;

FIG. 10 another exemplary embodiment of a screw with a boring tip;

FIG. 11 a cross-section along a line XI-XI in FIG. 10, with U-shaped grooves being provided; and

FIG. 12 a partial cross-section through an exemplary embodiment having two metal sheets with a self-boring screw being inserted.

### DETAILED DESCRIPTION OF THE PREFERRED EMBODIMENTS

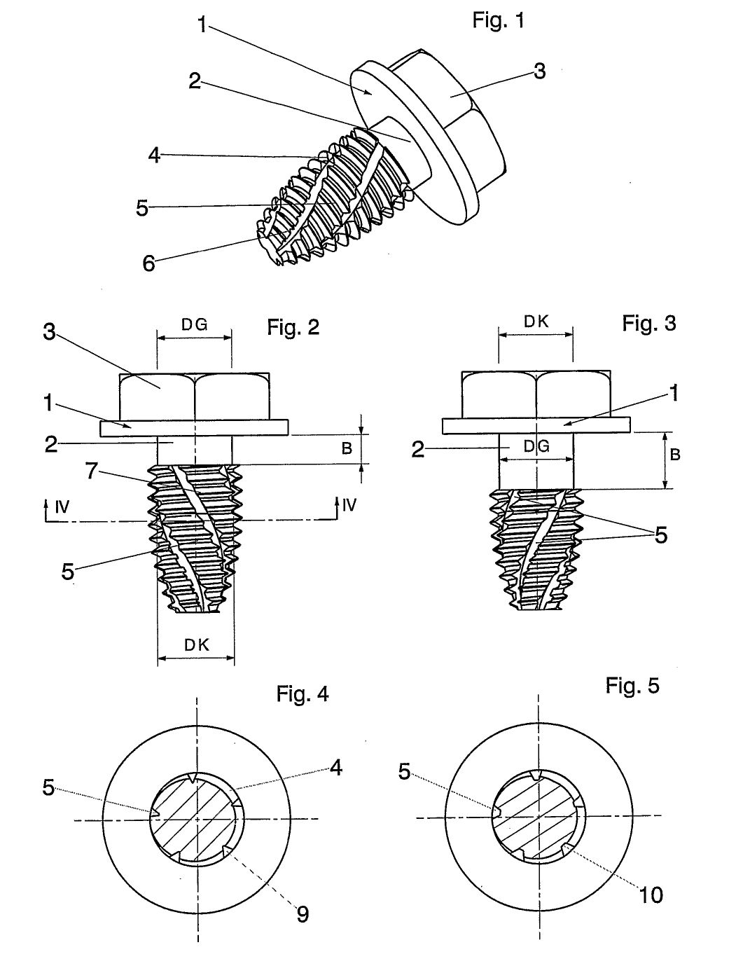

A screw 1 shown in FIG. 1 is provided with a thread-free section 2 between the screw head 3 and the thread 4. The thread 4 is provided with at least one groove 5 crossing the thread. In this way, a connection that is safeguarded from loosening can be achieved between two or more metal sheets 11, 14 by a single fastening element. When pre-punched metal sheets are used variants of the exemplary embodiment can be embodied in a conical shape at the end section 6 of the shank 7 in order to allow centering of the metal sheets 11, 14. In variants embodied in this manner, the conical end region 6 can be embodied in a tip. This end region 6 may also have a trilobularly shaped shank or be trilobular for the entire thread.

In a variant of the exemplary embodiment according to FIG. 2, a counter-clockwise groove 5 is provided, crossing the thread. This variant may be advantageous for an adjustment to the entire connection. If the diameter DG of the thread-free section 2 is smaller than the root diameter DK of the shank 7 it can be achieved that particularly the sheet metal close to the screw head 3 allows radial shifting and thus no tension or bending can develop in the sheet metal between two or more fastening points. In this way, large areas can be covered with sheet metal and present a high quality visual appeal. In most embodiments it is particularly useful if the grooves 5 taper off in the thread-free section 2, because this ensures particularly in thinner metal sheets that a reverse torsion of the screw 1 out of the sheet metal is prevented.

In another embodiment, FIG. 3 shows a screw 1 with several grooves 5, which are implemented in a clockwise direction. Depending on production and use, both an economical production as well as optimum adjustment to the overall fastening can be achieved The same also applies for other arrangements of the grooves 5, for example one parallel to the axis or other combinations of clockwise or counter-clockwise extending grooves.

The term “clockwise” and “counter-clockwise” indicate a clockwise or counter-clockwise alignment in reference to shank 7 and are to be interpreted in the same manner as “clockwise” and “counter-clockwise” for threads.

Another embodiment relates to the shape of the groove. FIG. 4 shows a cross-section through the shank 7, with the thread 4 being crossed by a V-shaped groove 5. A hollow space 9 is created by the groove 5 in the thread 4, which can be filled with a coat, for example an adhesive, lubricant, or the like. With this hollow space 9 it is ensured that during the screwing down process a large portion of the liquid is enclosed between the interior and the exterior thread. When lubricants are used, this provides that during screwing down of the thread, it is constantly provided with a fine liquid film. This can significantly reduce the torque required for the screwing down process. Inversely, using an adhesive can provide that the connection, after being screwed down, is additionally ensured against loosening by the adhesive.

In FIG. 5 the above-described effect is further optimized with the help of recesses 9 created by the formation of the groove 5 or other forms of a hollow space, by its form being trapezoidal or shaped in any other form. This creates a larger recess. In this way, even longer screws can be produced with constant performance. In addition to the shape of the groove 5, the groove 5 is preferably embodied with the depth 10 of the diameter DK of the thread root. The volume of the hollow space can also be achieved by a groove 5 that is deeper than the diameter DK of the thread root. Additionally, it is possible to apply less deep grooves on the thread.

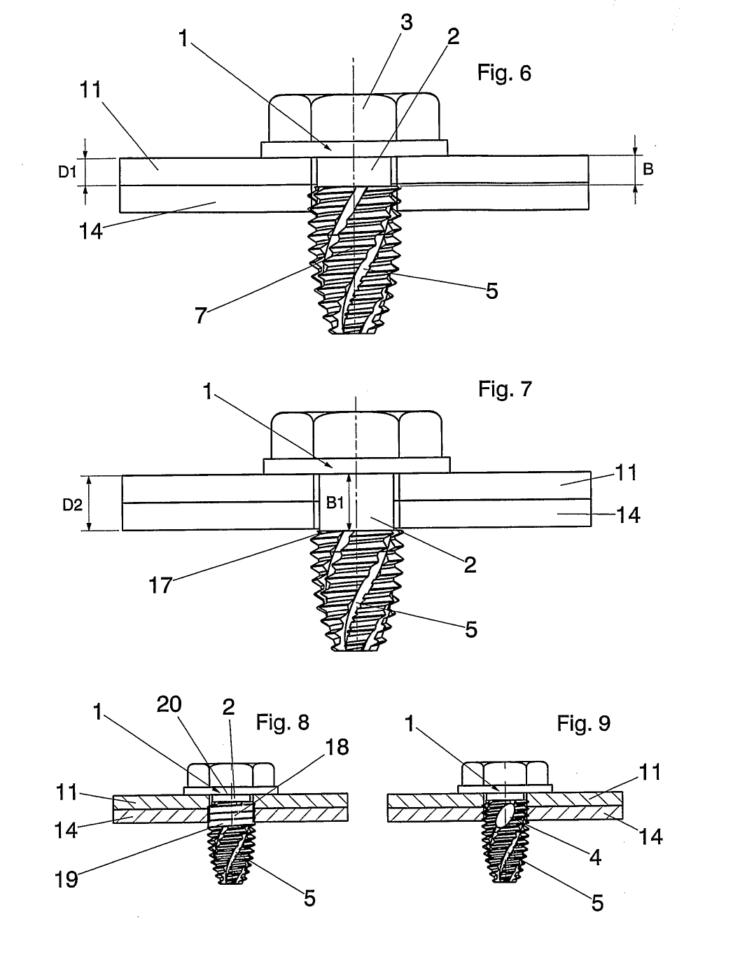

In another embodiment of the screw, according to FIG. 6, the width B of the thread-free section 2 is provided according to the thickness D1 of the sheet metal 11 positioned next to the bottom of the head 13. The sheet metal 11 facing away from the shank 7 is thus clamped during tightening between the screw head 3 and the exterior sheet metal 14.

FIG. 7 shows a further embodiment of the screw, in which the thread-free section 2 is provided with a width B1, which is approximately equivalent to the thickness D2 of all metal sheets 11, 14 to be connected to one another. When screwing down the screw 1, it can be inserted so far that all metal sheets to be fastened are positioned in the thread-free section 2. Due to the fact that during the reverse rotation the end 17 of the thread cannot any longer engage the sheet metal 14, it can be considered a non-detachable connection.

FIG. 8 shows a variant of an exemplary embodiment with a screw 1 having a coating 18 on the thread portion 19 adjacent to the thread-free section 2. In an exemplary embodiment according to FIG. 8, the clamping effect is considerably improved by the coat 18 and a connection secured from detachment is achieved by the hollow spaces 9 created by the groove 5 being filled with a coat 18. Accordingly, the tread-free section 2 can also be coated. Additionally, the bottom 13 of the screw head 3 can be provided with a coat 18. In this way, any arbitrary combination of coat location and coat types can be adjusted to the security and/or the lubricating features. Suitable coats 18 for clamping, adhesive, or other safety features include, among others, two—component adhesives, plastics, rubber, or the like. Wax, polytetrafluoroethylene (PTFE), plastic, or the like can be used as lubricants.

Another variant of the exemplary embodiment is shown in FIG. 9. In order to achieve the described clamping or lubricating effect, depending on application, a partial coat might already be sufficient, particularly applied on the groove, in order to yield sufficient clamping and/or lubricating effects. In particular, it is possible that a partial coating with a lubricant reduces the forming moment and that at that part of the thread, which after the screw down process is still contacting the sheet metal 14 with its thread 4, a clamping and/or adhesive coat is provided. The effects can be combined in any arbitrary manner.

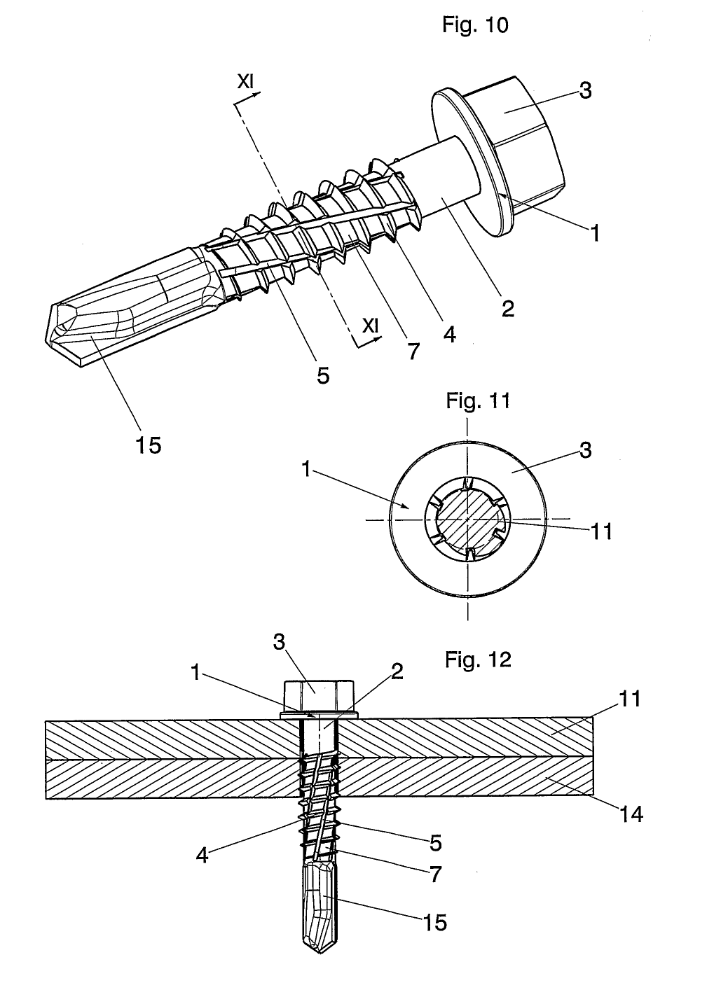

In FIG. 10 an embodiment of screw 1 is shown, which is provided with a boring tip 15 at the end section facing away from the screw head 3. This allows the creation of a connection in a single step without pre-drilling.

FIG. 11 shows a particular embodiment of the screw 1 with a U-shaped groove 5. This shape of the groove 5 is suitable to produce high reverse torque values for the thread 4.

FIG. 12 shows a self-drilling screw 1, which is suitable even for thicker metal sheets 11, 14 in that the metal sheets 11,14 are pulled towards one another by the thread-free section 2 and a connection is achieved which is secured from loosening by the grooves 5 crossing the thread 4.

1. A screw with a shank at least partially provided with a thread for screwing into a pre-formed hole and with a screw head, wherein a thread-free section is provided between the screw head and the thread, at least at an end region of the shank (7) facing the screw head (3), the thread (4) is provided with at least one groove (5) crossing the thread (4), that tapers off at the thread-free section (2), the thread (4) is formed trilobularly at an end section (6) facing away from the screw head, and a diameter (DG) of the thread-free section is at the most slightly larger than a root diameter (DK) of the thread on the shank.

2. A screw according to claim 1, wherein the thread-free section (2) has a smaller diameter (DG) than a root diameter (DK) of the shank (7).

3. A screw according to claim 1, wherein, a width (B) of the thread-free section (2) is equivalent to a thickness (D1) of a metal sheet (11) closest to a bottom of the head (13).

4. A screw according to claim 1, wherein, a width (B) of the thread-free section (2) is approximately equivalent to a thickness (D2) of all metal sheets (11, 14) to be fastened.

5. A screw according to claim 1, wherein the groove (5), notch, slot, or the like has U-shaped, V-shaped, or trapezoidal recesses (9) in the thread (4).

6. A screw according to claim 1, wherein two or more grooves (5) are provided.

7. A screw according to claim 1, wherein the groove (5) extends parallel to an axis of the shank (7).

8. A screw according to claim 1, wherein the groove (5) extends helically in a clockwise and/or counter-clockwise direction in reference to the shank (7).

9. A screw according to claim 1 wherein the groove (5) is formed to a depth of the root diameter (DK).

10. A screw according to claim 1, wherein the groove (5) is deeper than the root diameter (DK).

11. A screw according to claim 1, wherein a binding and/or adhesive coating (18) is applied to a thread portion (19) adjacent to the thread-free section (2).

12. A screw according to claim 1, wherein a binding and/or adhesive coating (18) is applied to the thread-free section (2) and/or a bottom (13) of the screw head.

13. A screw according to claim 11, wherein a two-component adhesive is applied as the coating (18).

14. A screw according to claim 11, wherein plastic is applied as the coating (18).

15. A screw according to claim 1, wherein wax, polytetrafluoroethylene (PTFE), or plastic is applied as a lubricating coating (18) at least to an end region (6) of the shank facing away from the screw head.

16. A screw according to claim 11, wherein the coating (18) is applied partially or over an entire circumference.

17. A screw according to claim 1, wherein the thread (4) is formed trilobularly at the end section (6) facing away from the screw head.

18. A screw according to claim 1, wherein the shank (7) is provided with a conically tapering thread (4) at the end section (6) facing away from the screw head.

19. A screw according to claim 1, wherein the thread (4) tapers to a tip at the end section (6) facing away from the screw head.

20. A screw according to claim 1, wherein the end section (6) facing away from the screw head (3) is provided with a self-drilling or self inserting tip (15).
